(19) United States
(12) Patent Application Publication
(10) Pub. No.: US 2007/0199421 A1
(43) Pub. Date: Aug. 30, 2007

(54) Cutting head of an eccentric cutting machine

(76) Inventor: Ralf Peter Mueller, Kempten (DE)

Correspondence Address: PERMAN & GREEN, 425 POST ROAD, FAIRFIELD, CT, 06824, US

(21) Appl. No.: 10/565,408

(22) PCT Filed: Jul. 23, 2004
(86) PCT No.: PCT/EP04/08240

§ 371 Date: Jun. 30, 2006

(30) Foreign Application Priority Data
Jul. 23, 2003 (DE) 10333662.1

(51) Int. Cl. B23D 19/00

(52) U.S. Cl. 83/469

(57) ABSTRACT

The present invention relates to the cutting head of an eccentric cutting machine, including a drive shaft (7) which is mounted to rotate in relation to a machine frame (14) and on which a rotor (13) is arranged, in which a substantially disk-shaped knife (1) is mounted to rotate and eccentrically arranged in relation to the drive shaft (7). The invention also relates to a slicing machine provided with the cutting head.

The present invention relates to the cutting head of an eccentric cutting machine having a drive shaft mounted rotatably relative to a machine frame, on which drive shaft a rotor is arranged, in which a blade, arranged eccentrically relative to the drive shaft, is rotatably mounted. Furthermore, the present invention relates to a slicing machine having the cutting head according to the invention.

Eccentric cutting machines, which are also known as slicers, serve to slice up foodstuffs in block form, for example sausage, ham, bacon, cheese, meat and the like.

Such machines, which operate with a very fast cutting sequence, are in practice required to provide precise cuts irrespective of the type of particular product to be sliced. Since the blades rotate very quickly and sometimes hard, in particular even chilled, foodstuffs have to be sliced precisely over extended periods, the bearing arrangement for mounting the blades has to meet stringent requirements with regard to precision and long service life. There has therefore been no shortage of attempts to provide particularly robust bearings. For example, a drive and bearing arrangement for a cutting head of an eccentric cutting machine is known from DE-OS 37 13 536 which comprises a special bearing arrangement for accommodating radial and axial forces. However, this arrangement has the disadvantage that the bearing arrangement is subject to very considerable forces, such that it is not possible to achieve very high cutting speeds and lubricants provided for lubricating the bearing arrangement may come into contact with the product to be cut and thus contaminate the product.

The object of the present invention is therefore to provide a cutting head for an eccentric cutting machine with which very high cutting speeds may be achieved and in which contamination of the product to be sliced with substances foreign to the product is prevented at least to the greatest possible extent.

The object is achieved with a cutting head according to one of claims 1-5. Advantageous embodiments of the cutting head are described in the subclaims.

It was extremely surprising to the person skilled in the art, and wholly unexpected, that substantially higher rotational speeds and cutting performance can be achieved with the cutting head according to the invention. It has proven possible to reduce considerably the forces and bending moments to which the bearing arrangement is subject and thus heating and wear thereof. By using the cutting head according to the invention, contamination of the product to be sliced with substances foreign to said product is prevented at least to the greatest possible extent. The cutting head according to the invention requires substantially less maintenance than cutting heads according to the prior art. The cutting head according to the invention is simple and cheap to produce. Lubrication of the bearing arrangement of the cutting head has been improved in comparison with the prior art.

Any bearing arrangement known to the person skilled in the art is suitable as the bearing arrangement of the blade. However, the bearing arrangement is preferably a ball or roller bearing or a combination thereof.

The blade is preferably mounted on a spindle connected non-rotatably with the housing of the rotor. For the purposes of the invention, a spindle does not rotate, while a shaft or hub does rotate. The spindle preferably projects out of the rotor housing.

It is also preferable for the blade to comprise a hub which is mounted on a spindle by means of the bearing arrangement. The hub and the blade may be of one-piece construction. However, it is also feasible for the blade to be attached, for example screwed, preferably reversibly on the hub.

It is particularly preferable for the hub to be so constructed that it at least partially encloses the bearing arrangement. This embodiment has the advantage that lubricant for lubricating the blade bearing arrangement is encapsulated by the hub and thus cannot in practice come into contact with the product to be sliced.

In order even more efficiently to prevent discharge of the lubricant, the hub is preferably sealed with a seal relative to the rotor or the spindle, such that the bearing arrangement is completely enclosed relative to the product area.

The hub is preferably driven. Very particularly preferably, this drive is effected by at least one shaft, of which at least one is connected with the hub in such a way that torque may be transmitted.

In a particularly preferred embodiment, the cutting head is temperature-controlled, preferably cooled, such that the cutting head may be heated when starting from cold and cooled during operation. The cooling prevents the blade from overheating, such that there is no negative effect on the productive capacity of the cutting head and cutting quality. It is very particularly preferable for the rotor, the drive shaft thereof and the bearing arrangement thereof to be at least partially temperature-controlled, preferably cooled. In the case of the rotor, the spindle on which the hub or the blade is mounted and/or the bearing arrangement thereof is temperature-controlled, preferably cooled.

When using oil as the temperature-control medium, the bearings may be cooled at least in part directly, by exposing them directly to a liquid flow, which additionally results in optimum lubrication. This form of lubrication and/or cooling lengthens the service life of the bearings.

Cooling is preferably effected with water, which, particularly preferably, is circulated.

The cutting head is very particularly preferably inclined relative to vertical by an angle α. This embodiment has the particular advantage that the lubricant would have to flow against gravity in order to flow out of the cutting head according to the invention, which is virtually impossible.

The present invention further provides a slicing machine comprising the cutting head according to the invention.

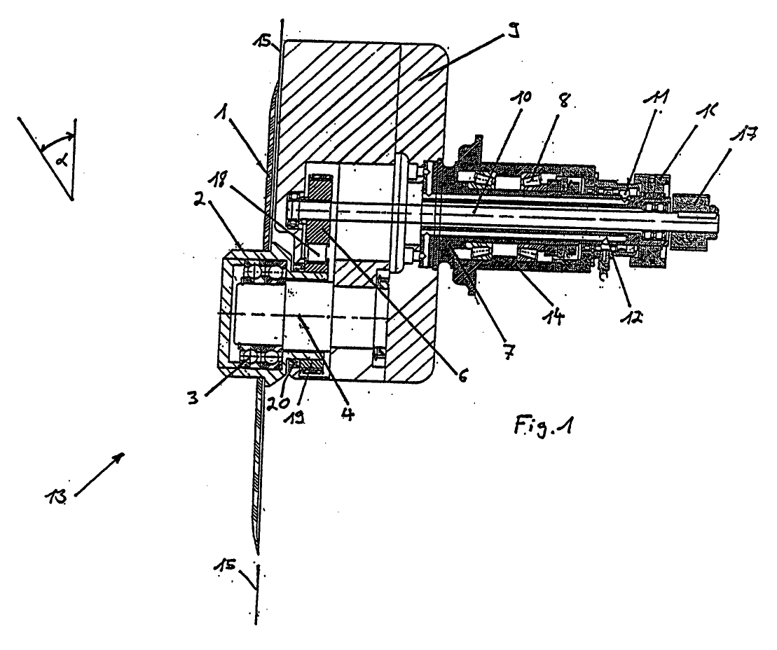

The invention is explained below with reference to FIGS. 1-3. These explanations are given purely by way of example and do not restrict the general concept of the invention.

FIG. 1 shows an embodiment of the cutting head according to the invention.

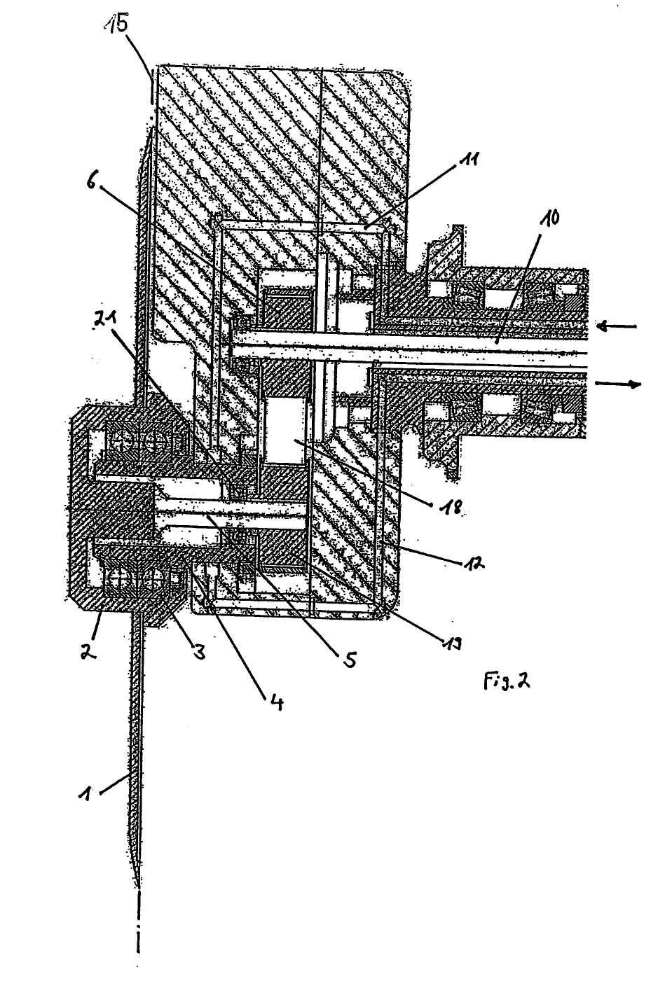

FIG. 2 shows a further embodiment of the cutting head according to the invention together with cooling.

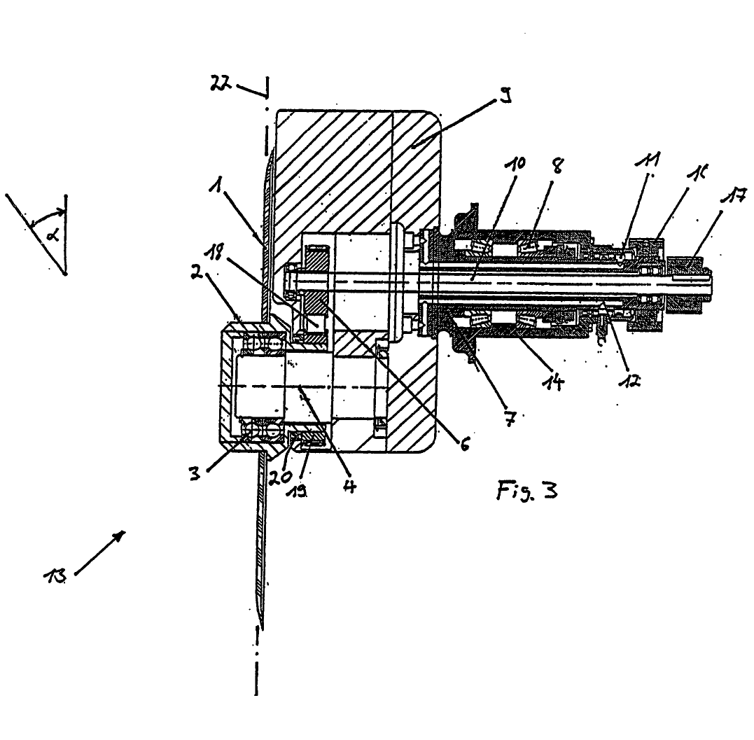

FIG. 3 shows a third embodiment of the cutting head according to the invention.

FIG. 1 shows the cutting head according to the invention. A hollow shaft 7 is mounted rotatably on the bearing housing 14, which shaft 7 may be driven at one end by means of the toothed belt wheel. At the other end of the shaft 7 there is located the rotor 13, in whose housing 9 there is rotatably mounted a blade 1 arranged eccentrically relative to the drive shaft 7. The blade cuts the product to be sliced (not shown) in the cutting plane 15. The blade 1 is attached, for example screwed, to the hub 2, which is mounted by means of the bearing arrangement 3 rotatably on the spindle 4 connected non-rotatably with the housing 9. The hub 2 may also be designated a hollow shaft, which is internally bearing-mounted. The person skilled in the art will recognise that the bearing arrangement 3 of the blade is arranged in the area of the cutting plane 15 of the blade 1, such that the forces or moments acting on the bearing are reduced considerably in comparison to the prior art. Furthermore, the person skilled in the art will recognise that the bearing arrangement 3 is not enclosed by the housing 9. A toothed belt wheel 19 is arranged on the hub (shaft) 2, said wheel cooperating via a toothed belt 19 with a toothed belt wheel 6, which is in turn arranged at one end of the drive shaft 10 of the blade. At the other end of the drive shaft 10 there is attached a further toothed belt wheel 17, by which the drive shaft 10 and thus the hub (shaft) 2 and ultimately the blade 1 are driven. Since the rotor 13 rotates, the blade moves on a planetary path. The person skilled in the art will recognise that rotation of the blade 1 takes place in the present case independently of the rotation of the rotor 9. However, this does not have to be the case. The hub (shaft) 2 completely encloses the bearing arrangement 3 and one end of the spindle 4, such that discharge of lubricant provided for the bearing 3 is prevented to the greatest possible extent, in particular when the cutting head is inclined by the angle α relative to vertical. In addition, lubricant loss is reduced by the seal 20. As a result of the bearing arrangement 3 being located inside the hub (shaft) 2, lubrication thereof is substantially better than in the prior art, in which the bearing arrangement of the shaft of the blade is generally located at the outer circumference of the shaft, because, in the case of the cutting head according to the invention, the outer ring of the bearing 3 rotates and thus the lubricant, which is forced outwards by the movement of the rotor and the blade in the bearing, is constantly redistributed.

In the present case, the cutting head according to the invention comprises a temperature-control means, which is outlined by ducts 11 and 12 and illustrated in detail in FIG. 2 and with which temperature control of the bearings 8, the shaft 10, and in particular the bearings 3 and/or the spindle 4 is effected. During start-up, for example, warm water may be circulated through the ducts, in order to ease start-up. After start-up, cooling water is then circulated through the ducts 11, 12, in order to prevent inadmissible heating of the blade, which would reduce the cutting efficiency and cutting quality of the cutting head. However, it is also feasible for the cutting head according to the invention to be constantly heated or constantly cooled.

FIG. 2 shows a further embodiment of the cutting head according to the invention. In the present case, the hub 2 is driven via a shaft 5, on which a toothed belt wheel 19 is arranged, which cooperates via the toothed belt 18 and the toothed belt wheel 6 with the drive shaft 10. The person skilled in the art will recognise that, in this case too, the hub 2 is principally mounted rotatably by means of the bearings 3 on the spindle 4 connected non-rotatably with the housing 9 and that the bearing 3 is arranged inside the hub 2, such that the bearing arrangement exhibits the above-described advantages with regard to lubrication. The bearing arrangement 3 mainly accommodates the forces arising during rotation of the blade or the rotor and during cutting. The bearing arrangement 3 of the blade 1 is arranged in the area of the cutting plane 15 of the blade 1, such that the forces or moments acting on the bearing are reduced considerably in comparison to the prior art. The person skilled in the art will recognise that the bearing 21 serves substantially to support the drive forces in the radial direction. The high, radially acting cutting forces arising at the blade are accommodated by the bearing arrangement 3. Cutting forces in the axial direction are markedly smaller than the radial cutting forces, such that the bearing 21 may accommodate these, so providing axial relief for the bearings 3. The bearing arrangement 3 of the blade 1 is not enclosed by the housing 9.

In addition, circulation of a temperature-control medium, preferably a fluid, particularly preferably an aqueous fluid, is shown schematically by the two arrows. However, gases or other liquids are also feasible. The water flows through the duct 11 into the rotor 13 and there heats and/or cools in particular the spindle 4 and thus the bearing arrangement 3 and the hub 2, such that heating up of the blade 1 is at least reduced. After cooling, the liquid flows via the duct 12 out of the cutting head according to the invention, is cooled and reused for cooling purposes. The person skilled in the art will understand that the liquid does not have to be circulated. The explanations relating to cooling also apply analogously to the cutting head according to FIGS. 1 and 3.

FIG. 3 shows the cutting head according to FIG. 1, except that in the present case the blade 1 is not bearing-mounted in the area of the cutting plane but rather in the area of the axial centre of gravity.

### LIST OF REFERENCE NUMERALS

1 Blade
2 Hub
3 Bearing arrangement of blade
4 Spindle
5 First drive shaft of blade
6 Toothed belt wheel
7 Drive shaft of rotor
8 Bearing arrangement of rotor
9 Rotor housing
10 Second drive shaft of blade
11 Cooling water feed
12 Cooling water discharge
13 Rotor
14 Bearing housing
15 Cutting plane
16 Toothed belt wheel
17 Toothed belt wheel
18 Toothed belt
19 Toothed belt wheel
20 Seal
21 Bearing arrangement
22 Centre of gravity

1-17. (canceled)

18. A cutting head of an eccentric cutting machine having a drive shaft (7) mounted rotatably relative to a machine frame (14), on which drive shaft (7) a rotor (13) with a housing (9) is arranged, in which a blade (1), arranged eccentrically relative to the drive shaft (7), is rotatably mounted, characterised in that the bearing arrangement (3) of the blade (1) is arranged on a spindle (4) oriented substantially parallel to the drive shaft (7) and connected non-rotatably with the housing (9) of the rotor (13).

19. A cutting head of an eccentric cutting machine according to claim 18, characterised in that the bearing arrangement (3) of the blade is arranged in the axial plane of gravity (22) of the blade (1)

20. A cutting head of an eccentric cutting machine according to claim 18, characterised in that the bearing arrangement (3) of the blade is arranged in the cutting plane (15).

21. A cutting head of an eccentric cutting machine according to claim 18, characterised in that the bearing arrangement (3) of the blade is arranged at least partially outside the housing (9).

22. A cutting head of an eccentric cutting machine according to claim 18, characterised in that the blade (1) is connected to a hub/shaft (2), whose bearing arrangement (3) is arranged inside the hub/shaft (2).

23. A cutting head according to claim 18, characterised in that the spindle (4) is a hollow spindle.

24. A cutting head according to claim 18, characterised in that the blade comprises a hub (2), which is mounted on a spindle (4) by means of the bearing arrangement (3).

25. A cutting head according to claim 18, characterised in that the spindle (4) projects out of the housing (9).

26. A cutting head according to claim 18, characterised in that the hub (2) at least partially encloses the bearing arrangement (3).

27. A cutting head according to claim 18, characterised in that a seal (20) is arranged between hub (2) and rotor (13).

28. A cutting head according to claim 18, characterised in that the hub (2) is driven by at least one drive means (5, 6, 10, 18, 19).

29. A cutting head according to claim 11, characterised in that the hub (2) is driven by a shaft (5).

30. A cutting head according to claim 18, characterised in that the rotor (13), the shaft (7) and/or the bearing arrangement (8) thereof is(are) at least in part temperature-controlled, preferably cooled.

31. A cutting head according to claim 18, characterised in that the spindle (4) and/or the bearing arrangement (3) is(are) temperature-controlled, preferably cooled.

32. A cutting head according to claim 30, characterised in that temperature control, preferably water-cooling, is particularly preferably effected with a water circuit (11, 12).

33. A cutting head according to claim 18, characterised in that it is inclined relative to vertical.

34. A slicing machine comprising a cutting head according to claim 18.
